(19) United States
(12) Patent Application Publication
(10) Pub. No.: US 2014/0374554 A1
(43) Pub. Date: Dec. 25, 2014

(54) Protective Magnetic Holder

(71) Applicant: Regina Jordan, Scranton, PA (US)

(72) Inventor: Regina Jordan, Scranton, PA (US)

(21) Appl. No.: 13/924,659

(22) Filed: Jun. 24, 2013

(51) Int. Cl. F16M 13/02; A47G 1/17

(52) U.S. Cl. CPC F16M 13/022; A47G 1/17
USPC 248/206.5

(57) ABSTRACT

A protective magnetic holder is provided for holding a wide variety of items. The holder is comprised of at least one magnet that may be fully encapsulated in a protective housing. The protective housing is made of a soft and durable materials that prevents scratching and damage to the magnetically attractive surface to which the holder is affixed.

### CROSS-REFERENCE TO RELATED APPLICATIONS

Not Applicable.

### STATEMENT REGARDING FEDERALLY SPONSORED RESEARCH

Not Applicable.

### BACKGROUND

1. Field of Invention

The present invention relates to magnetic apparatuses used to hold target items in place and off the ground.

2. Description of Related Art

Magnetic holders are well known in the art. The most popular are refrigerator magnets used to hold items such as photos, letters, cards, and the like to the metallic surface of a refrigerator. But beyond refrigerator magnets, magnetic holders have been used in other contexts such as, for example, the magnetic cell phone holder disclosed in U.S. Pat. No. 6,888,940. Magnetic holders provide inherent advantages since they are capable of bearing the load put on them by the target object to be supported but can be easily removed from the mounting surface with no changes made to that surface (e.g., like the holes left behind when nails are used to hold a target item in place).

There are, however, problems with known magnetic holders. Typical magnetic holders comprise one or more magnetic components that can scratch and damage the mounting surface. This is especially troublesome for applications where the user places a great amount of value on preventing damage to the mounting surface, such as in the case with magnetic holder mounted to a side of a motor vehicle. There is accordingly a need for a magnetic holder that is capable of bearing desired loads while at the same time refrains from scratching or damaging the mounting surface. Moreover, there is also a need for a magnetic holder that is durable enough to withstand certain outdoor environments that magnetic holder may be exposed to.

### SUMMARY

The present invention is a magnetic holder that will not scratch or damage the mounting surface to which it is magnetically attached. The present invention is comprised of a magnet and a buffer material such as silicone. When completely surrounding the magnet, the buffer material prevents the magnet from coming into direct contact with the mounting surface and thereby protects the mounting surface from scratches and damage. Other embodiments leave the magnet partially exposed outside of the buffer material.

In certain embodiments of the invention, the magnetic holder is shaped to hold a cylinder, such as an aluminum can filled with a beverage, that allows a user to affix his or her beverage to the side of an automobile or the like. Other embodiments include certain horse grooming applications that allow, for example, a user to hang horse tack on the outside of a horse trailer while grooming and preparing a horse.

### BRIEF DESCRIPTION OF THE DRAWINGS

FIG. 1 is a perspective view of a protective magnetic holder that is consistent with the present invention.

FIG. 2 is a perspective view of a protective magnetic holder that is consistent with the present invention.

FIG. 3 is a perspective view of a protective magnetic holder that is consistent with the present invention.

FIG. 4 is a side view of a protective magnetic holder that is consistent with the present invention.

### DETAILED DESCRIPTION

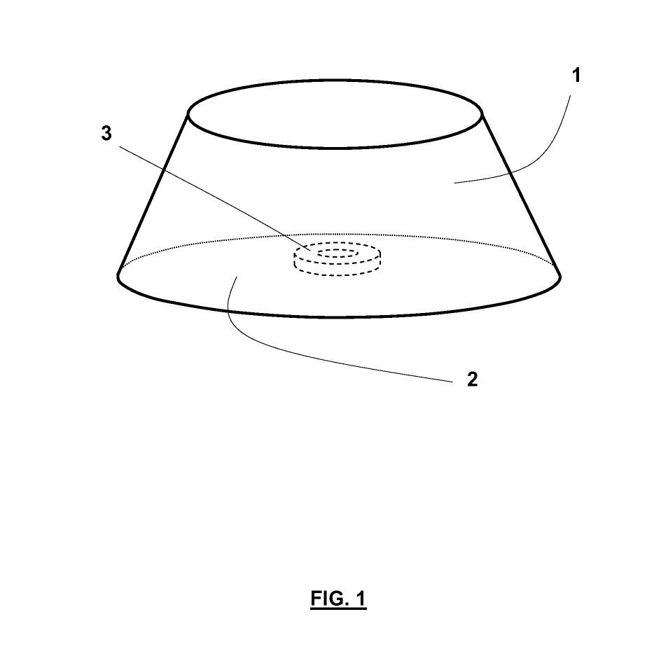

FIG. 1 illustrates a protective magnetic holder constructed according to a first preferred embodiment of the present invention. The present invention comprises a protective housing 1. The housing 1 may be constructed out of any durable material or materials (e.g., plastic, rubber, neoprene, leather, textiles, wood, ceramic), and is preferably made of silicone. The housing 1 has a base side 2 and may be comprised of one or more additional sides. As shown in FIG. 1, a magnet 3 is placed inside the housing 1 close to the base side 2 of said housing 1 but not parallel thereto. Although the illustrated embodiments use a disc magnet, the magnet 3 may be of any size, shape, and strength which achieves the same result. Moreover, in addition the to the embodiments disclosed herein, the housing 1 may be of any size and shape as desired to perform its intended operation of holding different types of items in place (e.g., picture frames, towel racks, etc.). In addition, embodiments of the invention may be comprised of more than one (1) magnet 3. Moreover, embodiments of the invention may further comprise a pull tab (not shown in the drawings) that would allow for the holder to be more easily removed from a magnetic surface.

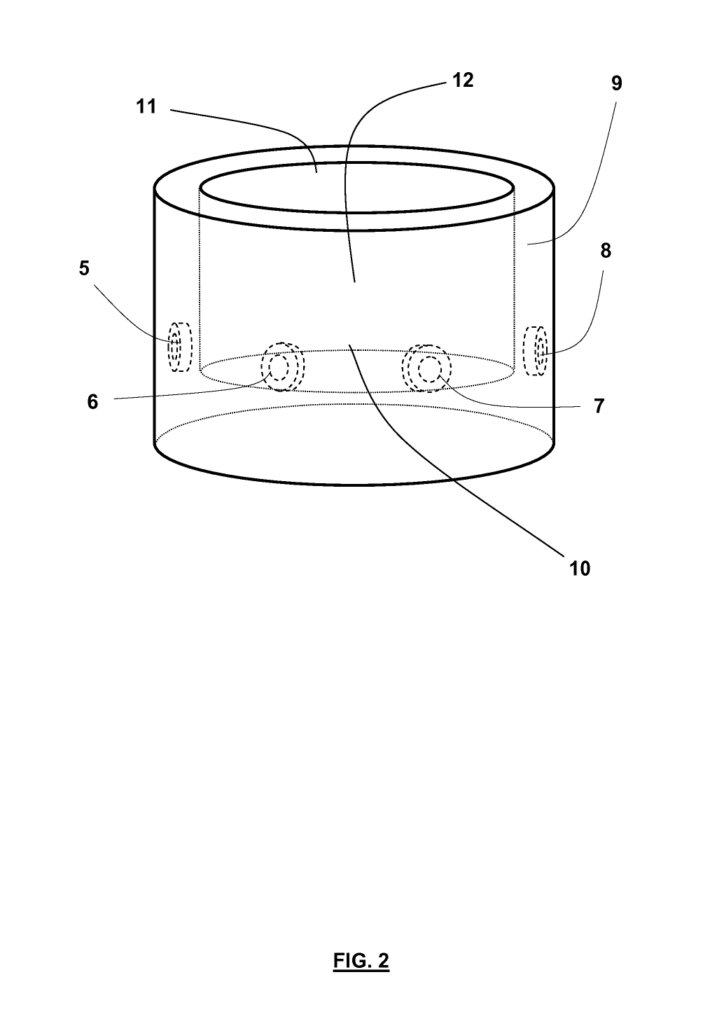

FIG. 2 illustrates an embodiment of the present invention that can be used to hold cylindrical objects, such as an aluminum beverage can. As shown in FIG. 2, one (1) or more magnets (5, 6, 7, 8) is placed within the housing 9 and positioned near the housing's 9 base side 10. The housing 9 for this embodiment is comprised of an opening 11 and a channel 12 that allows the cylindrical object to be inserted into and held in place by the housing 9. When in use, the embodiment of the present invention shown in FIG. 2 allows a user to place the base side 10 of the housing 9 against a magnetically attractive surface (e.g., the side of an automobile, a surface painted with metallic paint) and thereby hold the cylindrical object upright and in place. The housing 9 prevents damage to the magnetically attractive surface. The user can then easily retrieve the cylindrical object by grabbing the housing 9 and removing the protective magnetic holder from the surface. In addition, graphics such as athletic team logos can be displayed on the exterior of the housing 9.

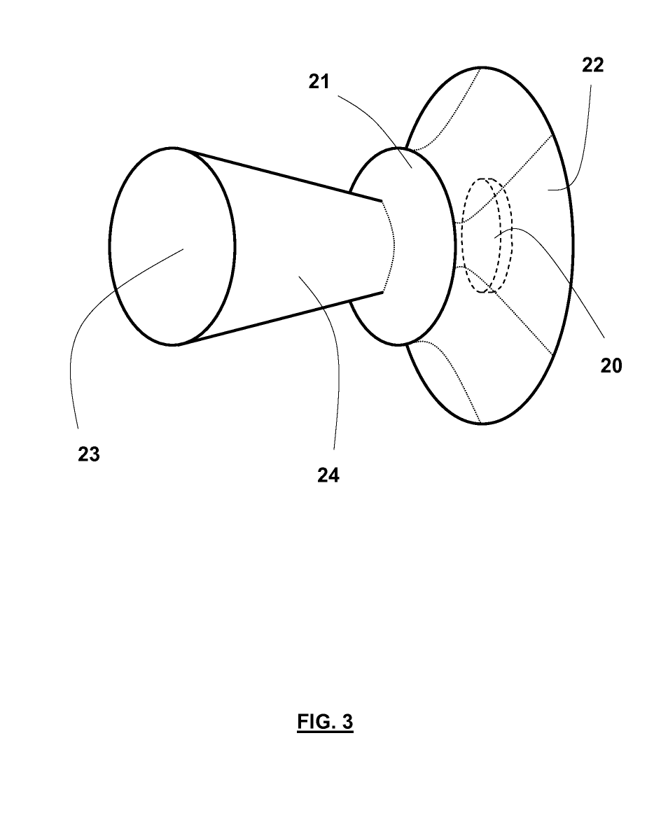

FIG. 3 illustrates an alternative embodiment of the present invention that can be used in horse grooming applications. As shown in FIG. 3, the magnet 20 is placed within the housing 21 and positioned near the housing's base side 22. Extending perpendicular from the housing's 21 base side 22 is an extension 23, the shaft 24 of which increases in circumference as the extension 23 extends from the housing's 21 base side 22. When the embodiment shown in FIG. 3 is affixed to the side of, for example, a horse trailer, the shaft 24 extends parallel to the ground. The increase in circumference allows items such as horse tack to be draped over the protective magnetic holder and held in place. This embodiment of the present invention is particularly useful in horse grooming applications because hooks and hangers for tack cannot be permanently affixed to a horse trailer when the trailer is in transit. By using the present invention, a user can temporarily affix protective magnetic holders to the side of the trailer when it is stationary and hang equipment on them without having to go inside the trailer and back again. Later, when the user no longer needs to hang equipment on the exterior of the trailer, the holders can be removed from its exterior. The embodiment shown in FIG. 3 is intended to be illustrative of the type of shapes the protective housing may take in order to fulfill certain needs.

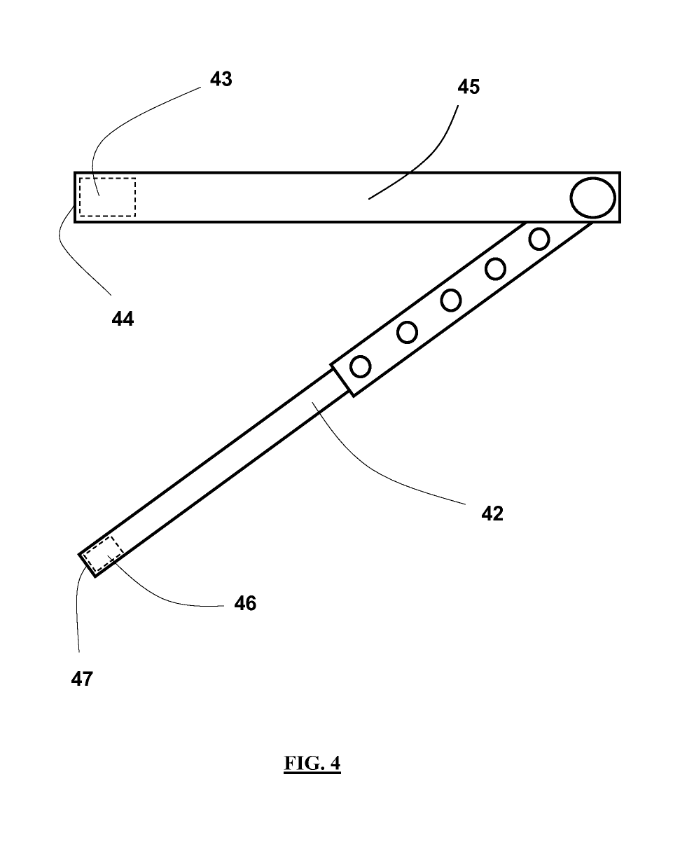

FIG. 4 illustrates an alternative embodiment of the present invention that further comprises a kick stand 42 that adds to the load-bearing capacity of the invention. As shown in FIG. 4, a magnet 43 is placed near the inner edge 44 of the protective housing 45. An additional magnet 46 is placed at the terminal end 47 of the kick stand 42. As shown in FIG. 4, the kick stand 42 can be made to swivel about the protective housing 45 and the kick stand's 42 length can be made adjustable through any known means such as a ball detent. The protective housing may also be comprised of an internal support structure, such as a metal frame.

While the invention has been described in conjunction with specific embodiments thereof it is evident that many alternatives, modifications and variations will be apparent to those skilled in the art. Accordingly, the preferred embodiments of the invention, as set forth herein, are intended to be illustrative, not limiting. Various changes may be made without departing from the true spirit and full scope of the invention, as defined in the following claims.

What is claimed is:

1. A protective magnetic device, comprising:
(a) a housing constructed of a soft and durable material, said housing having a substantially flat base side; and
(b) at least one magnet positioned inside said housing in close proximity to said base side.

2. The magnetic device of claim 1, wherein said housing is constructed of silicone.

3. The magnetic device of claim 1, wherein said housing is shaped to envelop and hold a cylindrical-shaped object.

4. The magnetic device of claim 1, wherein said housing comprises a shaft extending perpendicularly from said base side.

5. The magnetic device of claim 1, further comprising a kick stand.

6. A protective magnetic device, comprising:
(a) a housing constructed of a soft and durable material, said housing having a substantially flat base side; and
(b) at least one magnet positioned partially inside said housing in close proximity to said base side.
